(19) United States
(12) Patent Application Publication
(10) Pub. No.: US 2009/0298427 A1
(43) Pub. Date: Dec. 3, 2009

(54) System And Method For Processing Transactions Without Providing Account Information To A Payee

(75) Inventors: Rex Carlton Wilkinson, Columbus, GA (US); Franklin Scot Yarbrough, Columbus, GA (US); Jimmy McCoy, Columbus, GA (US)

Correspondence Address: KING & SPALDING, 1180 PEACHTREE STREET , NE, ATLANTA, GA, 30309-3521, US

(73) Assignee: Total System Services, Inc., Columbus, GA (US)

(21) Appl. No.: 12/474,753

(22) Filed: May 29, 2009

Related U.S. Application Data
(60) Provisional application No. 61/130,456, filed on May 30, 2008.

(51) Int. Cl. G06Q 20/00; G06Q 30/00; G06Q 40/00; H04B 7/00; G06F 15/16

(52) U.S. Cl. 455/41.1; 705/44; 705/17; 709/204; 455/41.2; 705/14.53

(57) ABSTRACT

Processing financial transactions. without providing information associated with a financial account of a purchaser to the payee of the transaction. A financial institution (card issuer) holding the account can provide a financial account, such as a credit or debit card account to the purchaser (card holder). The card holder can set up a payment option corresponding to this account at a mobile gateway computing system. Instead of presenting the card to a merchant, the card holder can access a payment application executing on a mobile device to select the payment option and extract transaction information from a merchant point of sale. This transaction information can be transmitted to the mobile gateway computing system along with payment option information. The mobile gateway computing system can add account information for the payment option and send the information to the card issuer for approval.

### STATEMENT OF RELATED PATENT APPLICATIONS

This non-provisional patent application claims priority under 35 U.S.C. §119 to U.S. Provisional Patent Application No. 61/130,456, titled Method and System for Mobile Gateway Program, filed May 30, 2008. This provisional application is hereby fully incorporated herein by reference.

### FIELD OF THE INVENTION

This invention relates to systems and methods for processing financial transactions. More particularly, this invention relates to systems and methods for processing financial transactions without providing information associated with a financial account of a purchaser to the payee of the transaction.

### BACKGROUND OF THE INVENTION

The use of financial cards, such as a debit card or credit card, for conducting financial transactions is ubiquitous. Typically, a credit card is a plastic card that represents a line of credit that has been issued from a financial institution, the card issuer, to an individual or business, the card holder. The credit card allows the card holder to purchase goods and services against the line of credit. Credit cards may be issued by national card associations, such as AMERICAN EXPRESS or DISCOVER CARD; a financial institution in conjunction with a national card association, such as Bank of America VISA or MASTERCARD; or directly from a retailer, such as MACY'S or BRITISH PETROLEUM.

A debit card is typically a plastic card that represents a financial deposit account held by a card holder at a financial institution. The debit card allows the account holder to purchase goods and services using the funds available in the deposit account. Debit cards are typically issued by the financial institution holding the deposit account in conjunction with a national card association.

Credit card and debit card transactions follow similar processes. A card holder can make a purchase at a merchant's location by presenting the card to a cashier or by scanning the card at a merchant point of sale. The card holder can also make purchases online at a merchant's Internet website or through a merchant's telephone system by giving information associated with the card to the merchant. The information from the card (e.g., card number and expiration date) is taken by the merchant and sent, along with information about the purchase and the merchant, to a transaction processor to approve the transaction. If the card is a debit card, a personal identification number (“PIN”) may also be given by the card holder to the merchant and included in the information sent to the transaction processor. In other words, the card holder must provide account-specific information about the payment account to the merchant.

This transaction process leaves several opportunities for thieves or “hackers” to steal this information. First, an employee of the merchant can access the card information from the merchant's systems or from data kept on the merchant's receipts of the transaction. Second, some merchants may store card information on systems accessible from outside networks, such as the Internet, where hackers can gain access. Third, a merchant has little available means for verifying that a card belongs to a customer, especially if the card is used over the Internet or at an unmanned point of sale, such as a vending machine.

Accordingly, what is needed are systems and methods that provide for a more secure way of completing financial card transactions. Another need exists for systems and methods for completing financial card transactions without giving a payee or merchant information associated with the financial account of the payer.

### SUMMARY OF THE INVENTION

The present invention supports systems and methods for processing financial transactions without providing information associated with a financial account of a purchaser to the payee of the transaction.

An aspect of the present invention provides a system for completing a transaction using funding from a financial account provided to an account holder by an account provider without providing a merchant with information associated with the financial account or the account holder. This system includes a mobile gateway computing system operable to receive transaction data from the account holder, the transaction data including an identification of the account holder, an indication of a financial account of the account holder to fund the transaction, and merchant transaction data; access account data corresponding to the indicated financial account; and transmit at least a portion of the account data and a portion of the transaction data for approval of the transaction.

Another aspect of the present invention provides a method for completing a transaction using funding from a financial account provided to an account holder by an account provider without providing a payee with information associated with the financial account or the account holder. This method includes the steps of receiving, at a computing system, transaction data from the account holder, the transaction data including an identification of the account holder, an indication of a financial account of the account holder to fund the transaction, and merchant transaction data; accessing, by the computing system, account data corresponding to the indicated financial account; transmitting, by the computing system, at least a portion of the account data and a portion of the transaction data for approval of the transaction; receiving, at the computing system, an indication of whether the transaction is approved or declined; and if the transaction is approved, transmitting, by the computing system, an approval message to the payee.

Yet another aspect of the present invention provides a mobile device for use in completing a transaction using funding from a financial account provided to an account holder by an account provider without providing a payee with information associated with the financial account or the account holder. This mobile device includes a payment application executing on the mobile device. This payment application is operable to provide the account holder with information associated with financial accounts of the account holder; receive a selection of one of the financial accounts from the account holder; receive transaction data corresponding to the transaction; and transmit the transaction data and information associated with the selected financial account from the mobile device to a computing system for processing of the transaction.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description, in conjunction with the accompanying figures briefly described below.

FIG. 1 is a block diagram depicting a system architecture for processing financial transactions without providing information associated with a financial account of a purchaser to the payee of the transaction in accordance with an exemplary embodiment of the present invention.

FIG. 2 is an overall process flow diagram depicting a method for processing financial transactions without providing information associated with a financial account of a card holder to a merchant in accordance with an exemplary embodiment of the present invention.

FIG. 3 is a detailed process flow diagram depicting a method for using a payment application to complete a transaction in accordance with an exemplary embodiment of the present invention.

FIG. 4 is a detailed process flow diagram depicting a method for processing a transaction for approval in accordance with an exemplary embodiment of the present invention.

FIG. 5 is a detailed process flow diagram depicting a method for completing a transaction in accordance with an exemplary embodiment of the present invention.

FIG. 6 is a detailed process flow diagram depicting a method for completing a transaction using a payment application at an Internet website in accordance with an exemplary embodiment of the present invention.

### DETAILED DESCRIPTION OF THE EXEMPLARY EMBODIMENTS

The invention provides systems and methods for processing financial transactions. Specifically, the invention provides systems and methods for processing financial transactions without providing information associated with a financial account of a purchaser to the payee of the transaction in accordance with an exemplary embodiment of the present invention.

The invention can include one or more computer programs that embody at least a portion of the functions described herein and illustrated in the appended flow charts. However, it should be apparent that there could be many different ways of implementing aspects of the invention in computer programming, and these aspects of the invention should not be construed as limited to any one set of computer program instructions. Further, a skilled programmer would be able to write such computer programs to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer programs will be explained in more detail in the following description read in conjunction with the figures illustrating the program flow. Further, those skilled in the art will appreciate that one or more of the stages described may be performed by hardware, software, or a combination thereof, as may be embodied in one or more computing systems.

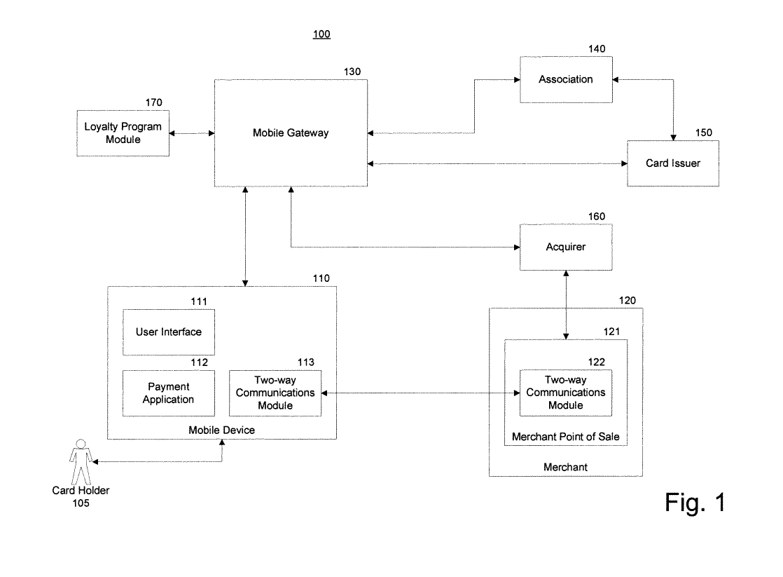

Turning now to the drawings, in which like numerals represent like elements throughout the figures, aspects of the exemplary embodiments will be described in detail. FIG. 1 is a block diagram depicting a system architecture 100 for processing financial transactions without providing information associated with a financial account of a purchaser to the payee of the transaction in accordance with an exemplary embodiment of the present invention. For the purpose of this application, the terms merchant and payee are used interchangeably to describe any payee in a financial transaction and can include a person, business, service provider or any other entity that receives a form of payment in a financial transaction.

Referring to FIG. 1, the system architecture 100 includes a mobile gateway 130 that interacts with a mobile device 110 associated with a card holder 105 and with a card issuer 150 to process transactions between the card holder 105 and a merchant 120. Although only one card holder 105 having a mobile device 110, one card issuer 150, and one merchant 120 is illustrated in FIG. 1, the mobile gateway 130 can interact with many card holders 105, many mobile devices 110, many card issuers 150, and many merchants 120.

The mobile gateway 110 is a computer, server, mainframe computer, or group of computers or servers that can store information associated with many card holders' 105 financial accounts for use in approving financial transactions between the card holders 105 and merchants 120 without providing any information associated with the financial accounts to the merchants 120.

The card holder 105 can be an individual or entity, such as a business, having a financial account with the card issuer 150. The financial account can take the form of any type of financial account, including a checking account, savings account, line of credit, money market account, or a pre-paid gift card account. The card issuer 150 can issue a card, such as a credit card or debit card, to the card holder 105 having the financial account with the card issuer 150. Although the term “card holder” is being used herein, the associated financial account does not have to be embodied in a physical card, such as a credit card. As such, the “card issuer” can be any account provider.

The card holder 105 can create an account with the mobile gateway 130 and set up one or more payment options with the mobile gateway 130. To create an account with the mobile gateway 130, the card holder 105 provides the mobile gateway 130 with card holder information. This card holder information can include the card holder's 105 name, address, mobile phone number, other contact information, a user name, a password, and any other information associated with the card holder 105. After the account is created, the card holder 105 can set up the payment options. The payment options can include any financial account held in conjunction with a card issuer 150, such as a checking account, a savings account, a line of credit, a money market account, a demand deposit account (“DDA”) or a pre-paid gift card account, for which a card or account has been established with the card issuer 150. For each payment option, the card holder 105 can provide the mobile gateway 130 with account information. This account information can include the name of the card issuer 150, an account number, a card number associated with a debit card or credit card, a card expiration date, an account nickname, and if applicable to the account, a personal identification number (“PIN”). For example, the card holder 105 can create a VISA credit card account nicknamed “Personal Credit Card” and a debit card account nicknamed “Checking Account” with the mobile gateway 130.

After setting up the payment options with the mobile gateway 130, the card holder 105 can complete transactions with a merchant 120 using funding from a financial account represented by a payment option at the mobile gateway 130 without providing the merchant 120 with any information associated with the card holder 105 or the financial account of the card holder 105. Thus, these transactions appear as anonymous to the merchant 120.

In one embodiment, the card holder 105 can use the mobile device 110 in place of a credit card or debit card. The mobile device 110 can be a mobile phone, personal digital assistant (“PDA”), or a mobile computing device. The mobile device 110 merely represents a communications device and can also be a non-mobile device, such as a desktop computer.

The mobile device 110 can include a payment application 112. The payment application 112 is a software application that can be installed on and executed the mobile device 110. Alternatively, the payment application 112 can be a web application accessed through a web browser at the mobile device 110. In a web application embodiment, the software application 112 may be provided by a web server (not shown) at the mobile gateway 130. The payment application 112 allows the card holder 105 to select one of the payment options that the card holder 105 set up at the mobile gateway 130 to fund a transaction with the merchant 120. The payment application 112 can receive information associated with the payment options from the mobile gateway 130 by way of an Internet connection between the mobile device 110 and the mobile gateway 130 or by way of a mobile phone carrier network if the mobile device 110 is a mobile phone or other device that communicates through a cellular network carrier.

The mobile device 110 can also include a two-way communications module 113 that can communicate with a merchant point of sale 121 having a two-way communications module 122. The two-way communications modules 113 and 122 can include hardware and software to support two-way communications protocols, such as near field communications (“NFC”), Bluetooth, and infrared (e.g., IrDA). The card holder 105 can hold the mobile device 110 near the merchant point of sale 121 and the two-way communications modules 113 and 122 can establish a connection. The merchant point of sale 121 can include the two-way communications module 122, a conventional card scanning device, and can communicate with a conventional product scanner. Additionally, the merchant point of sale 121 can be an unmanned point of sale having the two-way communications module 122, such as a vending machine or a “pay-at-the-pump” capable fueling station.

Prior to holding the mobile device 110 near the merchant point of sale 121, the card holder 105 can access the payment application 112 to select one of the payment options to fund the transaction with. The card holder 105 can access the payment application 112 by way of a user interface 111 provided by the payment application 112 at the mobile device 110. The user interface 111 can display the available payment options and receive a selection of the payment option from the card holder 105. In a web application embodiment, the user interface 111 can include a web browser.

After the payment option has been selected, the card holder 105 can hold the mobile device 110 near the merchant point of sale 121 to complete the transaction. The payment application 112 can communicate with the merchant point of sale 121 across the two-way communications established by the two-way communications modules 113 and 122. The payment application 112 can receive merchant transaction information from the merchant point of sale 121 and provide the merchant point of sale 121 with a confirmation number for the transaction. This merchant transaction information can include the total price of the transaction, information associated with each product or service (e.g., Stock Keeping Units “SKU,” or Universal Product Code “UPC”) of the transaction, information associated with the merchant 120, and information associated with the merchant point of sale 121.

The payment application 112 can communicate this merchant transaction data, along with a customer identification (“customer id”) and information associated with the selected payment option stored on the mobile device 110 to the mobile gateway 130. The mobile gateway 130 can access card holder data and the account information (e.g., card number and expiration date) of the selected payment option based on the customer id and the information associated with the selected payment option. The mobile gateway 130 can then transmit this account information, along with the merchant transaction data to the card issuer 150 for approval. The card issuer 150 can then use this information to approve or decline the transaction.

Depending on the type of payment option (i.e., credit card or debit card), the mobile gateway 130 can route the account information and information associated with the selected payment option to the card issuer 150 through an association 160 corresponding to the credit card (e.g., VISA) or a PIN network (not shown) corresponding to the debit card. Additionally, in some embodiments, the mobile gateway 130 can route the information directly to the card issuer 150. For example, if the card issuer 150 is a retailer that provides private label accounts, the retailer may receive the information directly from the mobile gateway 130. In another embodiment, the card issuer 150 can contract with a third party that processes the transaction to approve or decline the transaction. In such an embodiment, this third party may also operate the mobile gateway 130.

After determining if the transaction is approved or declined, the card issuer 150 can send a message indicating that the transaction is approved or declined to the mobile gateway 130. In some embodiments, the mobile gateway 130 can communicate this message to the mobile device 110 and the mobile device 110 can, in turn, communicate the message to the merchant point of sale 120. Additionally, in some embodiments, the mobile gateway 130 can communicate this message to the merchant point of sale 121 by way of an acquirer 160 associated with the merchant 120. The acquirer 160 is a financial institution or other type of organization that provides card processing services for a merchant 120. Some merchants 120, such as larger merchants and retailers, may not use the services of an acquirer 160. In these cases, the mobile gateway 130 can act as the acquirer 160 for the merchant 120. Alternatively, the card issuer 130 can perform the functions of the acquirer 160.

After the transaction has been completed, the card issuer 150 can settle the transaction with the merchant 120 by sending a settlement payment to the merchant 120. The card issuer 150 can send, along with the settlement payment, an indication of the confirmation number of the transaction so that the merchant 120 can match the payment to the transaction.

The mobile gateway 130 can also interact with a loyalty program module 170 to attach loyalty program data to the account information prior to sending to the card issuer 150. This loyalty program data can include the type of loyalty account, balance (such as points, airline miles, and reward stays at hotels), whether the loyalty points can be used to pay for a transaction, and whether the loyalty program may provide coupons or other discounts for the transaction. Many credit card issuers offer loyalty points to a card holder 105 for using the credit card. For example, some credit card issuers give a pre-determined number of points to a card holder 105 for each dollar spent using the credit card. If a payment option is set up at the mobile gateway 130 for a financial account having a loyalty program, this loyalty program data can be stored by the loyalty program module 170 and accessed by the mobile gateway 130 when a transaction involving the payment option is being processed. In one example, a cardholder 105 uses a credit card that earns airline miles—one mile for every dollar spent. The loyalty program module 170 would automatically update the number of miles in the card holder's 105 account based on the dollar amount of the transaction. In another example, a loyalty program may allow the card holder 105 to pay for a transaction with points from a loyalty program. In this example, the card holder 105 can select points from a loyalty program as the payment option. Once the transaction is approved, the loyalty program module 170 can deduct points from the cardholder's 105 account to pay for the transaction.

In yet another example, the loyalty program may allow for a “coupon” to be applied to the purchase of a particular product. In this example, the card holder 105 may scan a coupon at the merchant point of sale 121 to receive a discount for the product. The merchant point of sale 121 can capture information from the coupon. The merchant point of sale 121 can also capture the Stock Keeping Unit (“SKU”) or Universal Product Code (“UPC”) of the product when the product is scanned at the merchant point of sale 121. The loyalty program module 170 can use this coupon and product information, along with loyalty program data, to determine whether the coupon can be applied to the transaction. If the coupon can be applied to the transaction, the mobile gateway 130 can discount the value of the coupon from the transaction prior to transmitting the transaction data to the card issuer 150. Alternatively, the loyalty program module 170 can determine if a “coupon” can be applied to a transaction without the card holder 105 presenting a physical coupon. In this embodiment, the loyalty program module 170 evaluates the merchant transaction data and determines if the transaction is available for a discount. The loyalty program module 170 would then apply any available discounts. For example, a card holder 105 may purchase a COCA-COLA product. Further, the card holder 105 may be a member of a COCA-COLA loyalty program. The loyalty program module 170 would evaluate the merchant transaction data and determine that the transaction involves a COCA-COLA product. The loyalty program module 170 may then apply a $1.00 discount to the purchase. So, a $5.00 transaction may be modified such that the card holder 105 ends up paying $4.00 only, with the $1.00 “coupon” covering the rest of the transaction.

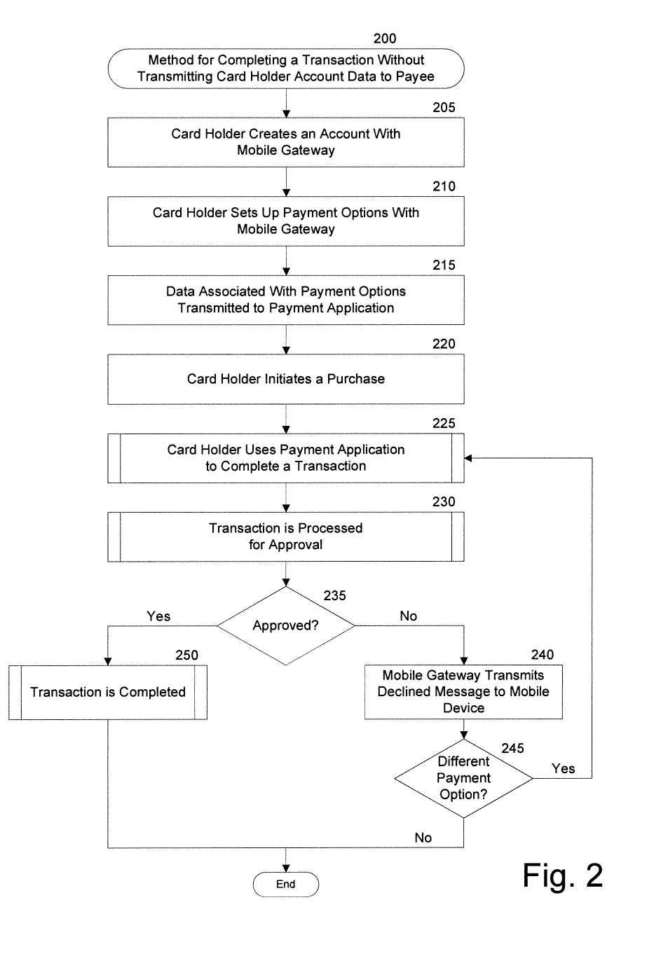

The system architecture 100 is described hereinafter with reference to the methods illustrated in FIGS. 2-5. These exemplary methods are illustrative and in alternative embodiments of the invention, certain steps can be performed in a different order, in parallel with one another, or omitted entirely, and/or certain additional steps can be performed without departing from the scope and spirit of the invention.

FIG. 2 an overall process flow diagram depicting a method 200 for processing financial transactions without providing information associated with a financial account of a card holder 105 to a merchant 120 in accordance with an exemplary embodiment of the present invention. The method 200 is described hereinafter with reference to FIGS. 1 and 2.

Referring to FIGS. 1 and 2, at step 205, the card holder 105 creates an account with the mobile gateway 130. To create an account, the card holder 105 provides the mobile gateway 130 with card holder information. As discussed above in connection with FIG. 1, this card holder information can include the card holder's 105 name, address, mobile phone number, other contact information, a user name, a password, and any other information associated with the card holder 105. In one exemplary embodiment, the card holder 105 can provide the card holder information to the mobile gateway 130 by way of an Internet website provided by the mobile gateway 130. Subsequently, the card holder 105 can “log into” the mobile gateway's 130 Internet website using the user name and password to manage the card holder's 105 account. The mobile gateway 130 can also assign the card holder 105 a customer id. After the account is created or modified by the card holder 105, the mobile gateway 130 stores the card holder information in a data storage unit, such as a database, stored on or coupled to the mobile gateway 130.

At step 210, the card holder 105 sets up one or more payment options with the mobile gateway 130. As discussed above, the payment options can include any financial account held in conjunction with a card issuer 150, such as a checking account, savings account, line of credit, money market account, DDA or a pre-paid gift card account. Another payment option is a loyalty program. For each payment option, the card holder 105 provides the mobile gateway 130 with account information associated with the payment option. As discussed above in connection with FIG. 1, this account information can include the name of the card issuer 150, an account number, a card number associated with a debit card or credit card, a card expiration date, an account nickname, and if applicable, a PIN. Similar to creating an account with the mobile gateway 130, the card holder 105 can set up and modify payment options by way of an Internet website provided by the mobile gateway 130. After the payment options are set up or modified by the card holder 105, the mobile gateway 130 stores the account information for each payment option in a data storage unit, such as a database, stored on or coupled to the mobile gateway 130.

In some exemplary embodiments, the card holder 105 can also create and manage an account with the mobile gateway 130 and manage the payment options by way of mail, electronic mail (“e-mail”) or a telephone system. For example, the card holder 105 can work with an operator or administrator to set up an account over the telephone system.

At step 215, the mobile gateway 130 transmits information associated with the payment options to the payment application 112 at the mobile device 110 associated with the card holder 105. If the mobile device 110 is a mobile phone or other device that communicates with a cellular network carrier, the mobile gateway 130 can send this information to the mobile device 110 by way of the mobile phone carrier network.

Alternatively, the card holder 105 can establish an Internet connection at the mobile device 110 and launch the payment application 112. The payment application 112 can then establish a connection with the mobile gateway 130 to receive the information associated with the payment options. In some exemplary embodiments, the mobile gateway 130 can transmit this information automatically based on a time period or when an account is created or modified. In some exemplary embodiments, the user interface 111 provided at the mobile device 110 can have a button or icon to allow the card holder 105 to initiate the transmittal of this information to the payment application 112.

In one exemplary embodiment, the information associated with the payment options includes the nickname of each payment option set up by the card holder 105 at the mobile gateway 130 only. Thus, no account information, such as card number or expiration date, is stored on the mobile device 110.

At step 220, the card holder 105 initiates a purchase. If the card holder 105 is in a store, the card holder 105 can gather any items that the consumer 105 intends to purchase and take the items to a cashier or self checkout station. The cashier or the card holder 105 can scan an identifier (e.g., SKU, or UPC) associated with each item at a merchant point of sale 121. The merchant point of sale 121 can gather information associated with each item and determine a total price for all of the items.

Additionally, the card holder 105 can initiate a transaction at an unmanned point of sale device, such as a vending machine or fueling station. Or, the card holder 105 can initiate a purchase with another person using a person-to-person transaction, where each person has a mobile device 110 having a two-way communications module 113. In a person-to-person transaction, the mobile device 110 of the payee of the transaction can act as the merchant point of sale 121.

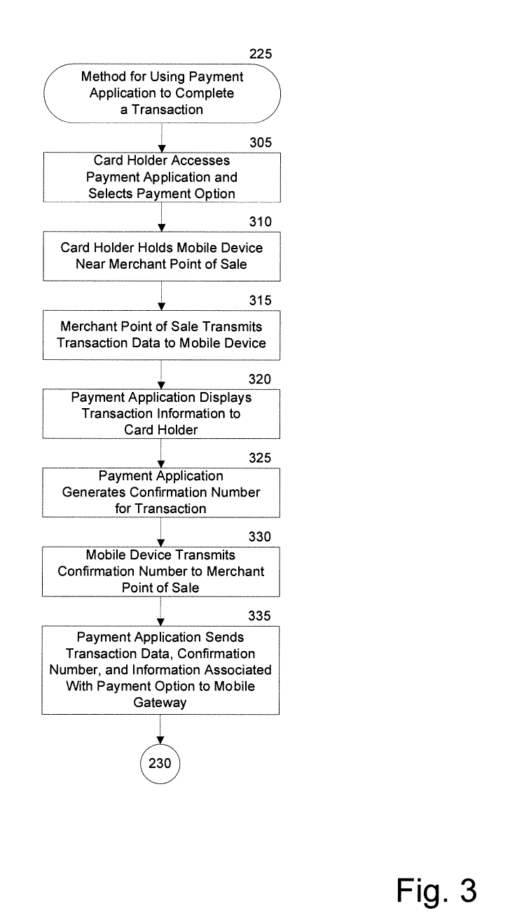

At step 225, the card holder 105 uses the payment application 112 to complete the purchase initiated at step 220. The card holder 105 accesses the payment application 112 and chooses one of the payment options. The card holder 105 then holds the mobile device 110 near the merchant point of sale 121 and the mobile device 110 and the merchant point of sale 121 establishes a connection across their respective two-way communications modules 113 and 122. After the connection is established, the merchant point of sale 121 transmits merchant transaction data to the payment application 112 on the mobile device 110. As discussed above in connection with FIG. 1, this merchant transaction data can include the total price of the transaction, information associated with each product or service (e.g., SKU, UPC, travel information) of the transaction, information associated with the merchant 120, and information associated with the merchant point of sale 121. The payment application 112 generates a confirmation number corresponding to the transaction and the mobile device 110 transmits the confirmation number to the merchant point of sale 121. The payment application 112 sends, by way of the mobile device 110, this confirmation number, along with the merchant transaction data received from the merchant point of sale 121, information associated with the selected payment option, and the customer id of the card holder 105 to the mobile gateway 130. For simplicity of discussion, this information is hereinafter referred to as mobile transaction data. In one exemplary embodiment, mobile transaction data is combined into one mobile transaction data file for transmittal from the mobile device 110 to the mobile gateway 130. This process of using the payment application 112 to complete a transaction is described in more detail herein in connection with FIG. 3.

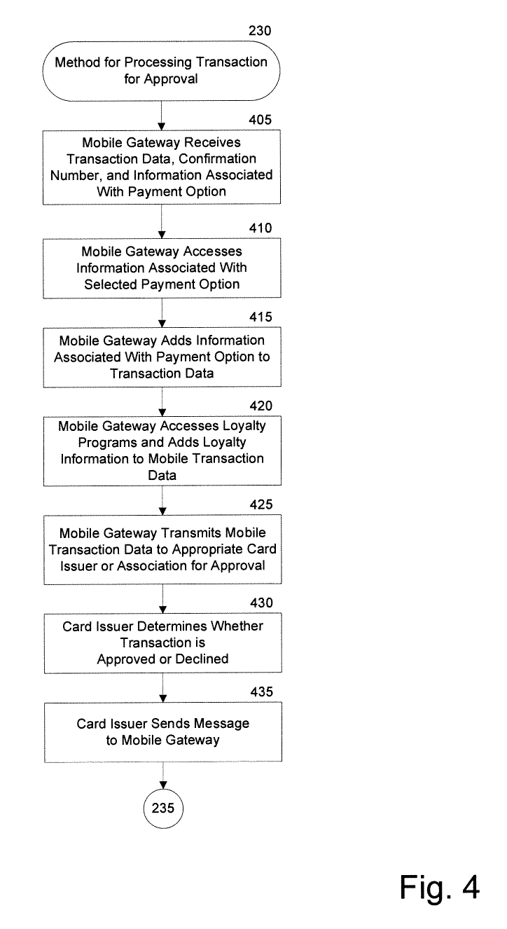

At step 230, the transaction is processed by the mobile gateway 130 and the card issuer 150 to approve or decline the transaction. After receiving the mobile transaction data, the mobile gateway 130 accesses the account information of the selected payment option. As discussed above in connection with step 210, this account information can include the name of the card issuer 150, an account number, a card number associated with a debit card or credit card, a card expiration date, an account nickname, and if necessary, a PIN. The mobile gateway 130 adds at least a portion of this account information to the mobile transaction data. Optionally, the mobile gateway 130 can also access loyalty and rewards 170 information associated with the card holder 105, selected payment option, merchant 120, or product or service to be purchased. If appropriate, loyalty information can be added to the mobile transaction data. The mobile gateway 130 then transmits the mobile transaction data to the card issuer 150 or association corresponding to the payment option for approval. The card issuer 150 determines whether to approve the transaction, and sends a message to indicate that the transaction is approved or declined to the mobile gateway 130. This method of processing a transaction for approval is described in more detail herein in connection with FIG. 4.

At step 235, if the transaction is approved in step 230, the method 200 proceeds to step 245. Otherwise, the method 200 proceeds to step 240.

At step 240, the mobile gateway 130 transmits a declined transaction message to the mobile device 110 to allow the card holder 105 the option of selecting another payment option. The payment application 112 can display the declined transaction message to the card holder 105 through the user interface 111. The payment application 112 can also prompt the card holder 105 to select another payment option. Alternatively, in some embodiments, the mobile gateway 130 can transmit the declined transaction to both the mobile device 110 and to the merchant point of sale 121 or only to the merchant point of sale 121.

At step 245, the card holder 105 can attempt the transaction again by selecting a different payment option. If the card holder 105 decides to attempt the transaction with a different payment option, the method 200 returns to step 225. Otherwise the method 200 ends.

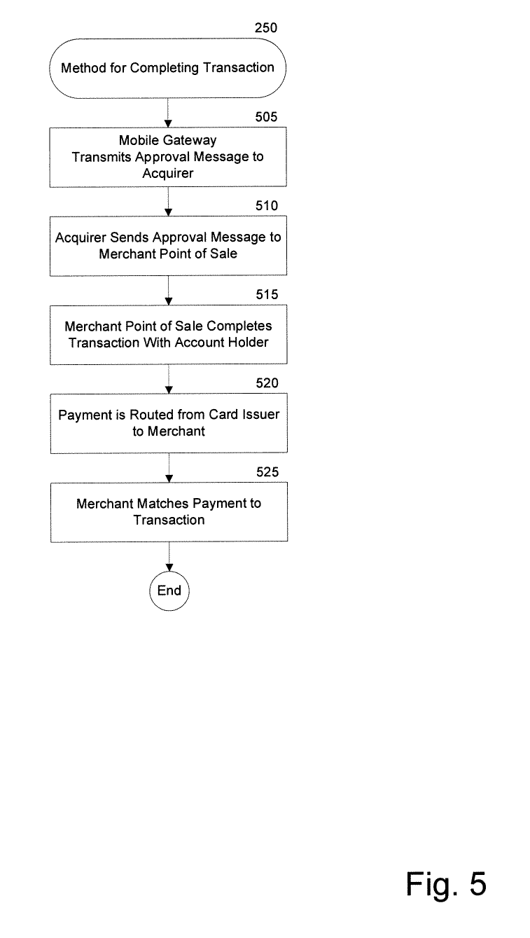

At step 250, the approved transaction is completed. To complete the transaction, the mobile gateway 130 transmits an approved transaction message to the merchant point of sale 121. The merchant point of sale 121 then completes the transaction with the card holder 105. The card issuer 150 transmits a payment for the transaction to the merchant 120 and the merchant 120 matches the payment to the transaction using the confirmation number generated in step 225. This process of completing the transaction is described in more detail in connection with FIG. 5.

FIG. 3 is a detailed process flow diagram depicting a method 225 for using a payment application 112 to complete a transaction in accordance with an exemplary embodiment of the present invention. The method 225 is described hereinafter with reference to FIGS. 1 and 3.

Referring to FIGS. 1 and 3, at step 305, the card holder 105 accesses the payment application 112 at the mobile device 110. The card holder 105 can launch the payment application 112 from the user interface 111 provided at the mobile device 110 or by pressing a “quick button” on the mobile device 110. In some exemplary embodiments, the payment application 112 may require that the card holder 105 enter a password or PIN for security purposes. After the payment application 112 is executing, the card holder 105 can select one of the payment options set up in step 210 of FIG. 2.

At step 310, card holder 105 hold the mobile device 110 near the merchant point of sale 121 and the two-way communication module 113 of the mobile device 110 establishes a connection with the two-way communications module 122 of the merchant point of sale 121. As described above, any two-way communications or data exchange protocols can be used, such as NFC, Bluetooth, and infrared (e.g., IrDA).

At step 315, the merchant point of sale 121 transmits merchant transaction data to the payment application 121 through the established connection between the two-way communications modules 113 and 122. As discussed above in connection with FIG. 1, this merchant transaction information can include the total price of the transaction, information associated with each product or service (e.g., SKU, UPC, travel information, price) of the transaction, information associated with the merchant 120, and information associated with the merchant point of sale 121. This merchant 120 information and merchant point of sale 121 information can include a merchant identification and a terminal or merchant point of sale 121 identification.

At step 320, the payment application 112 displays some or all of the merchant transaction data to the card holder 105 at the user interface for the card holder 105 to review and approve. If the selected payment option is a debit card or other account requiring a PIN, the payment application 112 will display an entry field for the card holder 105 to enter this PIN. Additionally, the payment application 112 can display entry fields for the card holder 105 to enter additional information, such as a tip amount, a cash back amount, or a pay with loyalty points option.

At step 325, the payment application 112 generates a confirmation number corresponding to the transaction and at step 325, the payment application 112 transmits this confirmation number to the merchant point of sale 121 through the established connection between the two-way communications modules 113 and 122. The merchant 120 or the merchant point of sale 121 can store this confirmation number in order to match a settlement payment from the card issuer 150 to the transaction.

At step 335, the payment application 112 accesses the information associated with the selected payment option and the customer id stored on the mobile device 110. The payment application 112 sends this information associated with the selected payment option and customer id, along with the merchant transaction data received from the merchant point of sale 121, and the confirmation number to the mobile gateway 130. As discussed above with reference to step 225 of FIG. 2, this combined information is referenced herein as mobile transaction data. In some exemplary embodiments, if the mobile device 110 has a location aware module, such as a Global Positioning System Receiver (“GPS”), the location of the mobile device 110 can also be included in the mobile transaction data.

If the mobile device 110 is a mobile phone or other device that communicates through a cellular network carrier, the payment application 112 can transmit the mobile transaction data to the mobile gateway 130 through the mobile phone carrier network. Alternatively, the payment application 112 can transmit the mobile transaction data by way of an Internet connection between the mobile device 110 and the mobile gateway 130. This mobile transaction data can be sent in one file or transmission or sent in separate files or transmissions. After step 330 is completed, the method 225 proceeds to step 230 of FIG. 2.

Although not shown in FIG. 3, the payment application 112 can communicate with the mobile gateway 130 to determine if all or part of the transaction can be paid for with loyalty points. If the card holder 105 has sufficient points, then an option to apply these points to the transaction can be presented to the card holder 105 at the mobile device 110. For example, if the card holder 105 is purchasing an airline ticket, the card holder 105 may use an airline credit card to pay for the ticket. After the payment application 112 receives the payment option (i.e., airline credit card) from the card holder 105 and the transaction data from the merchant point of sale 121, the payment application 112 can communicate with the mobile gateway 130 to determine if the card holder 105 has any airline miles to apply to the transaction. If so, the card holder 105 may be given the option to apply the miles to the transaction.

The payment application 112 and the mobile gateway 130 can also use this communication link to present advertisements, coupons, rebates, or other special offers to the card holder 105 at the mobile device 110. If the mobile device 110 has a location aware module, these offers can be selected based on the location of the mobile device 110.

FIG. 4 is a detailed process flow diagram depicting a method 230 for processing a transaction for approval in accordance with an exemplary embodiment of the present invention. The method 230 is described hereinafter with reference to FIGS. 1 and 4. Referring to FIGS. 1 and 4, at step 405, the mobile gateway 130 receives the mobile transaction data from the payment application 112.

At step 410, the mobile gateway 130 accesses the card holder information for the card holder 105 using the received customer id. If the mobile device 110 is a mobile phone, the mobile gateway 130 can access the card holder information using the phone number of the mobile phone. The mobile gateway 130 also accesses account information for the selected payment option stored at the mobile gateway 130.

At step 415, the mobile gateway 130 adds at least a portion of the account information of the selected payment option to the mobile transaction data. This data can include any data required by the card issuer 150 to approve the transaction, such as the account number, card number, expiration date, and the name of the card holder 105.

At step 420, the mobile gateway 130 accesses loyalty program data from the loyalty program module 170 and adds any loyalty program data to the mobile transaction data. As discussed above in connection with FIG. 1, loyalty program data can include the type of loyalty account, balance (such as points, airline miles, and reward stays at hotels), whether the loyalty points can be used to pay for a transaction, and whether the loyalty program may provide coupons or other discounts for the transaction. For example, if the card holder 105 is paying for the transaction with loyalty points, the points may be taken from the card holder's 150 account and this information can be added to the mobile transaction data. Or, if all or part of the transaction is eligible for receiving loyalty points, this information can be added to the mobile transaction data.

At step 425, the mobile gateway 130 transmits the mobile transaction data to the appropriate card issuer 150 for approval. If the selected payment option is a credit card, the mobile gateway 130 may transmit the mobile transaction data to the appropriate association 140 (e.g., VISA) and the association 140 can, in turn, forward the mobile transaction data to the card issuer 150. If the selected payment option is a debit card or other account requiring a PIN, the mobile gateway 130 may transmit the mobile transaction data to a PIN network for the card. The PIN network can verify the PIN that the card holder 105 entered and then forward the mobile transaction data to the card issuer 150.

At step 430, the card issuer 150 determines whether the transaction is approved or declined. The card issuer 150 may compare the total price of the transaction to an available balance or available credit line in the financial account that the payment option represents. The card issuer 150 may also examine additional information in the mobile transaction data, such as the expiration date of the payment option, merchant identification, or location of the merchant (determined from merchant identification). As stated above, a third party may provide transaction approval services for the card issuer 150.

At step 435, if the card issuer 150 approves the transaction in step 430, the card issuer 150 sends a message to the mobile gateway 130 indicating that the transaction is approved. If the card issuer 150 declines the transaction in step 430, the card issuer 150 sends a message to the mobile gateway 130 indicating that the transaction is declined. After step 435 is completed, the method 230 proceeds to step 235 of FIG. 2.

FIG. 5 is a detailed process flow diagram depicting a method 250 for completing a transaction in accordance with an exemplary embodiment of the present invention. The method 250 is described hereinafter with reference to FIGS. 1 and 5.

Referring to FIGS. 1 and 5, at step 505, the mobile gateway 130 transmits a message indicating that the transaction is approved to the acquirer 160 corresponding to the merchant 120. Along with this message, the mobile gateway 130 can transmit some of the mobile transaction data, such as the confirmation number, to the merchant point of sale 121 so that the merchant point of sale 121 can match the message to the transaction. However, information associated with the card holder 105 and information associated with the selected payment option is typically not sent to the acquirer 160.

At step 510, the acquirer 160 forwards the approved transaction message and any mobile transaction data received at the acquirer 160 to the merchant point of sale 121.

Alternatively, in some embodiments, the mobile gateway 130 can route the approved transaction message to the merchant point of sale 121 through the mobile device 110. Additionally, the mobile gateway 130 can transmit the approved transaction message to both the mobile device 110 and the merchant point of sale 121.

At step 515, the merchant point of sale 121 completes the transaction with the card holder 105. This may include notifying the card holder 105 that the transaction is approved and printing a receipt for the transaction. If the merchant point of sale 121 is an unmanned merchant point of sale, the transaction may be completed by releasing the product that the card holder 105 purchased. For example, if the merchant point of sale 121 is a bottled beverage vending machine, the vending machine may release a drink purchased by the card holder 105.

At step 520, the card issuer 150 updates the financial account represented by the payment option that was used to complete the transaction and routes a settlement payment for the amount of the transaction to the merchant 120 by way of the acquirer 160. This settlement payment can include an indication of the confirmation number of the transaction.

In step 525, the merchant 120 matches the settlement payment received from the card issuer 150 to the transaction using the confirmation number.

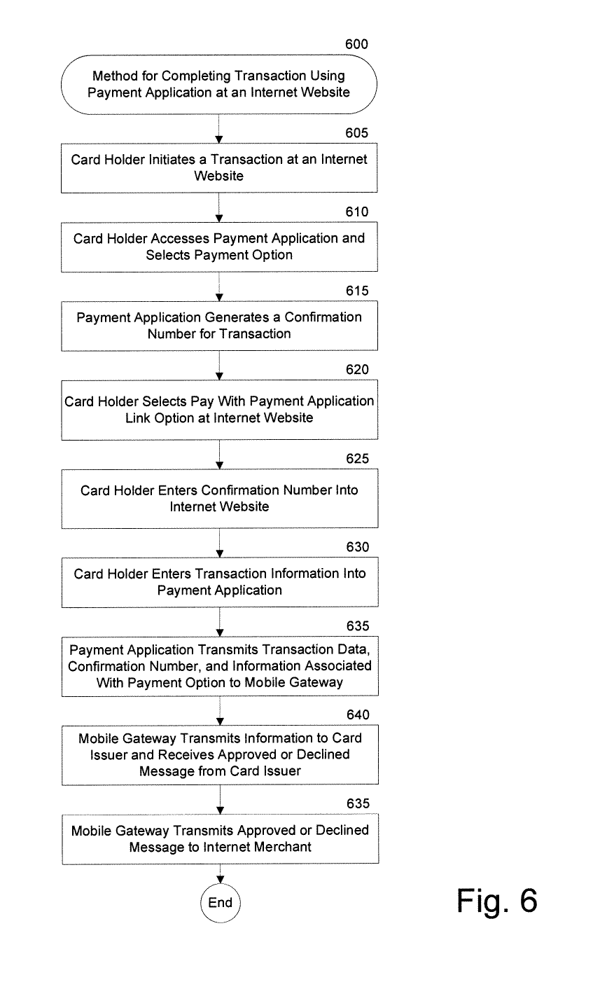

FIG. 6 is a detailed process flow diagram depicting a method 600 for completing a transaction using a payment application 112 at an Internet website in accordance with an exemplary embodiment of the present invention. The method 600 is an alternative embodiment to that of FIGS. 1-5 where a purchase is being made at an Internet website instead of at a merchant point of sale 121 or a person-to-person transaction. The method 600 is described hereinafter with reference to FIGS. 1 and 6.

Referring to FIGS. 1 and 6, at step 605, the card holder 105 initiates a transaction at an Internet website of an Internet merchant. The card holder 105 can select items for purchase at the Internet website. For example, the consumer can add items to an online “shopping cart.” The consumer 105 can then click a “checkout” icon to begin the payment process.

At step 610, the card holder 105 accesses the payment application 112 and selects the payment option for the transaction. Similar to the process of step 310 of FIG. 3, the card holder 105 can launch the payment application 112 from the user interface 111 provided at the mobile device 110 or by pressing a “quick button” on the mobile device 110. After the payment application 112 is executing, the card holder 105 can select one of the payment options set up in step 210 of FIG. 2.

At step 615, the payment application 112 generates a confirmation number for the transaction. In one exemplary embodiment, the card holder 105 can instruct the payment application 112 to generate a confirmation number by way of the user interface 111. In another exemplary embodiment, the payment application 112 may generate a confirmation number automatically when the card holder 105 selects a payment option. In yet another exemplary embodiment, the card holder 105 can select a button or icon on the user interface 111 for an Internet purchase and the payment application 112 can generate a confirmation number in response to the selection.

At step 620, the card holder 105 indicates to the Internet website that the method of payment is the payment application 112. The card holder 105 may select a button or icon on the Internet website to make this indication. The Internet website can then provide an entry for the confirmation number generated in step 615.

At step 625, the card holder 105 enters the confirmation number into the entry space provided by the Internet website.

At step 630, the card holder 105 enters merchant transaction data into the payment application by way of the user interface 111. Similar to the embodiments of FIGS. 1-5, this merchant transaction data may include the total price of the transaction, information associated with each product or service (e.g., SKU, UPC, travel information, price) of the transaction, information associated with the merchant 120, and information associated with the merchant point of sale 121 Alternatively, for simplicity of entry for the card holder 105, this merchant transaction information may only include the total price of the transaction, an identity of the Internet merchant, and a merchant confirmation number.

At step 635, the payment application 112 accesses the information associated with the selected payment option and the customer id stored on the mobile device 110. The payment application 112 sends this information associated with the selected payment option and customer id, along with the merchant transaction data received from the card holder 105, and the confirmation number to the mobile gateway 130.

At step 640, the mobile gateway 130 and card issuer 150 process the transaction for approval similar to the method 230 of FIG. 4. After processing the transaction, the card issuer 150 transmits a message to the mobile gateway 130 indicating whether the transaction is approved or declined.

At step 650, if the transaction is approved, the mobile gateway 130 can transmit a message to the Internet merchant indicating whether the transaction is approved. The Internet merchant can then complete the transaction with the card holder 105. If the transaction is declined, the mobile gateway 130 can transmit a message to the mobile device 110 so that the card holder 105 can have the option of selecting another payment option.

Although the method 600 has been described in terms of an Internet transaction, the method 600 can also be applied to a transaction over a telephone system of a merchant 120. In a telephone system embodiment, the card holder 105 can provide a telephone operator (or automated telephone system) with a confirmation number from the payment application 112. The card holder 105 can also receive merchant transaction information from the telephone operator and enter this merchant transaction information into the payment application 112. The payment application 112 can send this information to the mobile gateway 130 and the mobile gateway 130 can, along with the card issuer 160, process the transaction to approve or decline the transaction. The mobile gateway 130 can then send an approved or declined transaction to the merchant 120 and/or to the mobile device 110.

One of ordinary skill in the art would appreciate that the invention provides systems and methods for processing financial transactions. Specifically, the invention provides systems and methods for processing financial transactions without providing information associated with a financial account of a purchaser to the payee of the transaction in accordance with an exemplary embodiment of the present invention.

What is claimed:

1. A system for completing a transaction using funding from a financial account provided to an account holder by an account provider without providing a merchant with information associated with the financial account or the account holder, comprising:
a mobile gateway computing system, operable to:
receive transaction data from the account holder, the transaction data comprising an identification of the account holder, an indication of a financial account of the account holder to fund the transaction, and merchant transaction data;
access account data corresponding to the indicated financial account; and
transmit at least a portion of the account data and a portion of the transaction data for approval of the transaction.

2. The system of claim 1, wherein the mobile gateway computing system is further operable to receive an indication of whether the transaction is approved or declined.

3. The system of claim 2, wherein the mobile gateway computing system is further operable to transmit a message comprising the indication of whether the transaction is approved or declined.

4. The system of claim 1, wherein the merchant transaction data comprises at least one of a cost of the transaction, a merchant identification, and a merchant point of sale identification.

5. The system of claim 1, wherein the account data comprises at least one of an account number, a card number corresponding to a card issued by the account provider to the account holder, and an expiration date for the card.

6. The system of claim 1, wherein the mobile gateway computing system further comprises a loyalty program module operable to access loyalty program data.

7. The system of claim 1, wherein the transaction data is received from a payment application executing on a mobile device associated with the account holder.

8. The system of claim 7, wherein the payment application provides a user interface at the mobile device for receiving a selection of the financial account from the account holder.

9. The system of claim 7, wherein the mobile device comprises a two-way communications module for communicating with a merchant point of sale to receive the transaction data and to transmit a confirmation number to the merchant point of sale.

10. A method for completing a transaction using funding from a financial account provided to an account holder by an account provider without providing a payee with information associated with the financial account or the account holder, comprising the steps of:
receiving, at a computing system, transaction data from the account holder, the transaction data comprising an identification of the account holder, an indication of a financial account of the account holder to fund the transaction, and merchant transaction data;
accessing, by the computing system, account data corresponding to the indicated financial account;
transmitting, by the computing system, at least a portion of the account data and a portion of the transaction data for approval of the transaction;
receiving, by the computing system, an indication of whether the transaction is approved or declined; and
if the transaction is approved, transmitting, by the computing system, an approval message to the payee.

11. The method of claim 10, wherein the merchant transaction data comprises at least one of a cost of the transaction, a payee identification, and a payee point of sale identification.

12. The method of claim 10, wherein the account data comprises at least one of an account number, a card number corresponding to a card issued by the account provider to the account holder, and an expiration date for the card.

13. The method of claim 10, further comprising the step of accessing loyalty program data.

14. The method of claim 10, wherein the transaction data is received from a payment application executing on a mobile device associated with the account holder.

15. A mobile device for use in completing a transaction using finding from a financial account provided to an account holder by an account provider without providing a payee with information associated with the financial account or the account holder, comprising:
a payment application executing on the mobile device, the payment application operable to:
provide the account holder with information associated with a plurality of financial accounts of the account holder;
receive a selection of one of the plurality of financial accounts from the account holder;
receive transaction data corresponding to the transaction; and
transmit the transaction data and information associated with the selected financial account from the mobile device to a computing system for processing of the transaction.

16. The mobile device of claim 15, wherein the transaction data comprises at least one of a total cost of the transaction, and an identification of the payee.

17. The mobile device of claim 15, wherein the payment application is further operable to generate a confirmation number corresponding to the transaction.

18. The mobile device of claim 15, further comprising a two-way communications module for communicating with a point of sale device associated with the payee.

19. The mobile device of claim 18, wherein the payment application is operable to receive the transaction data from the point of sale device associated with the payee by way of the two-way communications module.

20. The mobile device of claim 18, wherein the two-way communications module comprises a near field communications module.

21. The mobile device of claim 18, wherein the two-way communications module comprises a Bluetooth module.
